(19) United States
(12) Patent Application Publication
(10) Pub. No.: US 2007/0223346 A1
(43) Pub. Date: Sep. 27, 2007

(54) Method for Improving Robustness of Optical Disk Readout

(75) Inventors: Gurdev Singh, Singapore (SG); Hendrik Josephus Goossens, Shanghai (CN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/570,624

(22) PCT Filed: Jun. 21, 2005
(86) PCT No.: PCT/IB05/52029

§ 371 Date: Dec. 14, 2006

(30) Foreign Application Priority Data
Jun. 28, 2004 (EP) 04102982.8

(51) Int. Cl. G11B 7/09

(52) U.S. Cl. 369/100

(57) ABSTRACT

The present invention relates to a method for improving the robustness of the readout from an optical disk in an optical disk drive, such as an optical disk of the following format: compact disk (CD), digital versatile/video disk (DVD) and Blu Ray disk (BD). The invention provides a way of obtaining an optimized radial tracking error signal using an open loop, i.e. with no feedback, in order to improve a subsequent closed loop control mechanism, preferably involving the radial tracking error signal. During the optimization of the open loop radial tracking error signal one ore more drive parameters of the optical disk drive is varied. It is a particular advantage of the invention that an improved optical read-out may be obtained if the optical disk has one or more parameters outside the specifications and/or standards associated with the optical disk. The present invention also relates to an apparatus for using the method, i.e. an optical disk drive.

The present invention relates to a method for improving the robustness of the readout from an optical disk, such as an optical disk of the following format: compact disk (CD), digital versatile/video disk (DVD) and Blu Ray disk (BD). The present invention also relates to an apparatus for using the method.

In an optical reproducing and/or recording apparatus for the light beam to trace accurately a track where pits or marks representing information are arranged in a row, a fast and precise control mechanism is indispensable. The optical reproducing and/or recording apparatus controls the position of the convergence of the light spot for reading the information, so that the light spot keeps tracing the track. The position control of the light spot is effected in two dimensions. The control in the direction of the optical axis is effected by focus control means, while control in the radial direction of the disk is effected by tracking control means. These controls are effected by feedback control in which the position of the light spot is controlled so as to eliminate the error, which is the difference between the target position of the light spot and the current position.

Several methods are available for obtaining the error in a radial direction, one such method being the push-pull (PP) method where a tracking error signal is generated on the basis of the level difference between optical signals detected in an optical sensor of the optical reproducing apparatus. In the differential time (or phase) detection (DTD) method, a phase difference between the optical signals detected in the optical sensors of the optical reproducing apparatus is applied for generating a radial tracking error signal. The DTD method was originally introduced by Braat as disclosed in U.S. Pat. No. 4,057,833.

A common problem encountered with reproducing and/or recording information stored on an optical disk is the fact that not all optical disks in the market are made according to their specific standard, one such standard being e.g. the ISO-9660 for CD-ROM, also known as the “High Sierra”. Especially, optical disks manufactured under little or no quality control may have so-called out-of-spec characteristics.

One of the typical out-of-spec characteristics is the substrate thickness of the optical disk being too large or too small. Alternatively, the angular deviation of the disk may be too large, i.e. the disk is skew. Both of these out-of-spec characteristics cause optical aberration, especially coma aberration for angular deviation and spherical aberration for thickness deviation. The aberration affects the quality of the read-out signal, but in particular also the quality of the radial tracking signal. In some instances, the quality may be so poor that no stable radial tracking can be obtained, thus the information on the optical disk cannot be reproduced.

In U.S. Pat. No. 6,339,567 an optical information reproduction method and apparatus is disclosed, which may solve some problems resulting from an optical disk having out-of-spec characteristics. The apparatus applies a tracking servo system using a tracking error signal operated by the DTD method, the effect of an offset which varies depending on e.g. manufacturing tolerances of the optical disk can be corrected, thus a tracking error signal free from offset can be obtained. In order to achieve this, phase comparison means, e.g. a charge pump in connection with an operational amplifier, are made to receive a certain set of input signals during the offset correction, and a different set of input signals during the tracking error signal detection. The offset in the tracking error signal varies depending on e.g. manufacturing tolerances of the optical disk. Through repeated learning control this offset may be corrected. However, the method of this reference essentially corrects the offset by applying a variable gain via the repeated learning mechanism in order to obtain a stable tracking error signal, thus a poor tracking error signal with e.g. a low signal-to-noise ratio (SNR) cannot be improved by this method. Hence, this method only applies to some out-of-spec disks unable to reproduce the information stored on the optical disk. Furthermore, the additional phase comparison means and their associated switching means complicates the electronic design and increase the cost of the apparatus.

It is an object of the invention to provide a method that solves the above-mentioned problems of the prior art with stable radial tracking of an optical disk in an optical disk drive. It is a further object of the invention to provide a method for optimizing any drive parameter associated with the disk drive under conditions where no stable radial tracking of the optical disk can be provided. In particular, it is an object of the invention to improve the optical readout of the optical disk in the disk drive if the optical disk has one or more out-of-spec characteristics.

These objects and several other objects are obtained in a first aspect of the invention by providing a method for improving the optical readout of an optical disk, the method comprising the steps of:
a) directing a light signal onto the optical disk in an optical disk drive,
b) detecting an optical response from the optical disk, and
c) determining whether stable radial tracking can be obtained from the optical response,

if stable radial tracking cannot be provided in step c, the method further comprises the steps of:
d) obtaining an open loop radial tracking error (OL-RTE) signal from the optical response of the optical disk,
e) varying at least one drive parameter of the optical disk drive,
f) determining at least one optimized value of a characteristic associated with the OL-RTE signal based on said variation, said at least one optimized value corresponding to a first drive parameter value of the optical disk drive, and
g) detecting an optical response from the optical disk at substantially the first drive parameter value.

It is a particular advantage of the invention that a quite broad range of drive parameters may be varied and possibly optimized with regard to one or more characteristics associated with the OL-RTE signal. This makes the method of the present invention highly flexible and capable of stabilizing the information reproduction and/or recording against a variety of defects and deficiencies of the optical disk drive and/or the optical disk. Relative to hitherto know optical disk drives that uses the RF signal for optimization by varying one or more drive parameter, it is an advantage of the present invention that the optimization only needs to be performed if stable radial tracking can not be obtained. Hence, the present invention may be faster in some instances.

It is a further advantage of the invention that the method may be implemented by relatively small modifications of a typical apparatus applied in the prior art, i.e. primarily the analysis of data during reproduction and/or recording and the control of the optical disk drive need substantial changes. This makes the invention simple and cost-effective to implement.

Preferably, the determination of whether stable radial tracking can be obtained in step c may comprise a phase-lock loop (PLL) of the optical response, preferably of a radio frequency (RF) signal of the optical response. A PLL analysis of the RF signal is often performed in state-of-the-art disk drives, hence the step may easily be implemented.

Preferably, the determination of whether stable radial tracking can be obtained in step c may comprise a closed loop radial tracking error (CL-RTE) signal. Preferably, the CL-RTE signal of step c, and/or the OL-RTE signal of step d, may comprise obtaining a differential time detection (DTD) signal from the optical response. Alternatively or additionally, the CL-RTE signal of step c, and/or the OL-RTE signal of step d, may comprise obtaining a push-pull (PP) signal from the optical response. Both DTD signals may be obtained for an optical disk of the DVD-DL and the DVD-SL formats, whereas the PP signal may be obtained for an optical disk of the DVD+RW and DVD+R formats. Therefore the method of the invention may be readily integrated with hitherto known optical disks.

It is a particular advantage of the present invention that an improved optical read-out may be obtained if the optical disk has at least one parameter outside the specifications and/or standards associated with the optical disk. A non-exclusive list of deviations from the specifications and standards may comprise: the thickness, the variation of the thickness, the angular variation, the thickness of one or more cover layers of the optical disk or the distance between the information layers. Due to the many different manufacturing facilities of optical disks today a considerable amount optical disks are produced under poor or insufficient quality control. Thus, this problem is becoming more and more important in this technical field, and it is a major advantage of the present invention that this problem at least to some extent may be solved.

Preferably, the variation of the at least one drive parameter in step e may be chosen from the non-exclusive group of: focus offset, collimator position, sledge tilt, lens radial position, lens tilt, and voltage on a compensating liquid crystal. These drive parameters are also varied in well-known optical disk drives, thus this part of the invention is readily integrated into such optical disk drives making the present invention a highly cost-effective solution.

Preferably, the method of the invention may be performed initially before reproducing the information stored on the optical disk and/or recording information on the optical disk as a part of a start-up procedure. It is an advantage that the optimization is only to be performed if no stable radial tracking can be obtained. Thus, if stable radial tracking is obtained initially no time is wasted on optimization. The method may also be performed while reproducing the information stored on the optical disk and/or recording information on the optical disk, thus no time is wasted during the start-up.

Preferably, the at least one drive parameter may be varied within an interval between a second drive parameter value and a third drive parameter value, the first drive parameter value, associated with the optimized value of a characteristics of the OL-RTE signal, being at least substantially equal to the second drive parameter value and at the most substantially equal to the third drive parameter value. This may be seen as an interval scheme of variation which is easy to implement, but in some instances may be relatively time consuming.

Alternatively or additionally, the at least one drive parameter may be varied by increasing from an initial drive parameter value to a fourth drive parameter value, said fourth drive parameter value having a fourth value of a characteristic associated with the OL-RT signal, and decreasing the initial drive parameter value to a fifth drive parameter value, said fifth drive parameter value having a fifth value of a characteristic associated with the OL-RTE signal, and comparing said fourth and said fifth value of a characteristic associated with the OL-RTE signal for determining an optimized value of a characteristic associated with the OL-RTE signal and/or determining a direction for further variation of the drive parameter. This may be seen as an differential scheme of variation which requires more data analysis of a characteristic associated with the OL-RT signal, but in some instances it may be relatively faster than the above mentioned interval scheme.

The variation of the at least one drive parameter to obtain an optimized value of a characteristic associated with the OL-RTE signal according to the present invention is not limited to any of the above listed schemes of variation. Rather, it is within the skilled persons capability to readily design several other variation schemes for obtaining an optimized value for a characteristic associated with the OL-RTE signal. Such variation schemes may comprise mathematical and/or statistical modeling of the OL-RTE signal.

Preferably, the characteristic associated with the OL-RTE signal may be chosen from the non-exclusive group consisting of: amplitude, peak-to-peak value, signal-to-noise ratio (SNR), mean value, a summation of a signal, a normalized signal and/or any combination thereof. Preferably, the characteristics of the OL-RTE signal may be averaged over a predefined period of time and/or number of revolutions of the optical disk in the optical drive. This is particular important for unstable characteristics of the OL-RTE signal, as it may be difficult to achieve reliable results otherwise.

In a second aspect, the invention also relates to an apparatus for implementing the method according to the first aspect of the invention, said apparatus comprising

holding means adapted to fixate and rotate an optical disk,

an optical head adapted to be displaced by actuation means in a radial direction of the optical disk, the optical head comprising;

a light source providing a light signal,

at least one objective lens adapted to focus the light signal to a light spot onto the optical disk, and

at least one photodetector for detecting an optical response of the optical disk, said at least one photodetector providing a least a first output signal,

at least one analyzing circuit adapted to analyse the at least first output signal and provide a second signal indicative of an error in the radial position of the optical head relative to the optical disk, and

control means adapted to receive the second signal, and said control means being capable of providing a control signal, in accordance with a pre-set scheme depending on the second signal, to the actuation means for radially displacing the optical head.

In a third aspect, the invention also relates to a computer program product being adapted to enable a computer system comprising at least one computer having data storage means associated therewith to control the method for improving the optical readout of an optical disc according the first aspect of the invention. In particular, the third aspect relates to both a computer program stored on data storage means, such as magnetic disks and optical disks, and to computer programs transmitted through a network, such as the internet (world wide web) or similar networks.

These and other aspects of the invention will be apparent from and elucidated with reference to the embodiments described hereinafter.

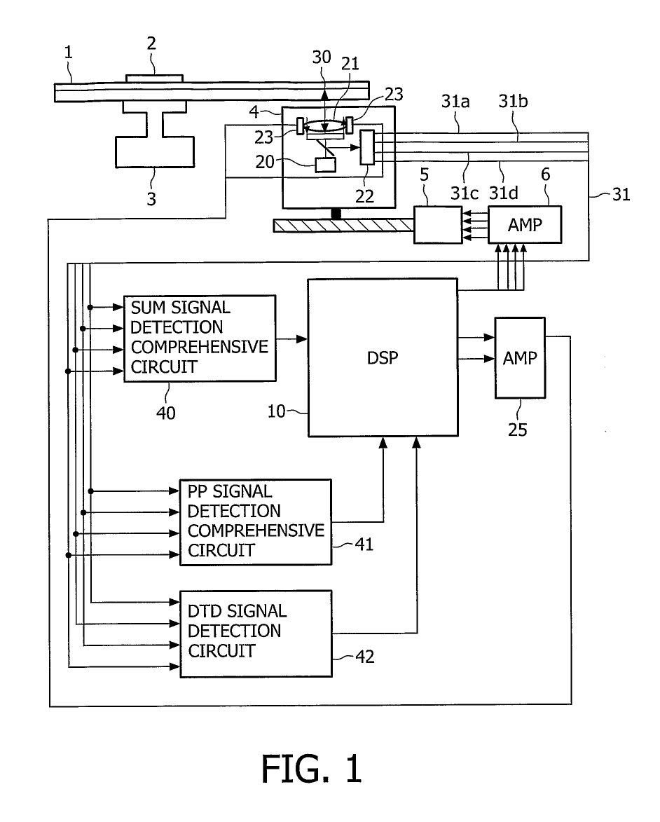

FIG. 1 shows a block diagram of a preferred embodiment of the optical disk drive according to the second aspect of the present invention.

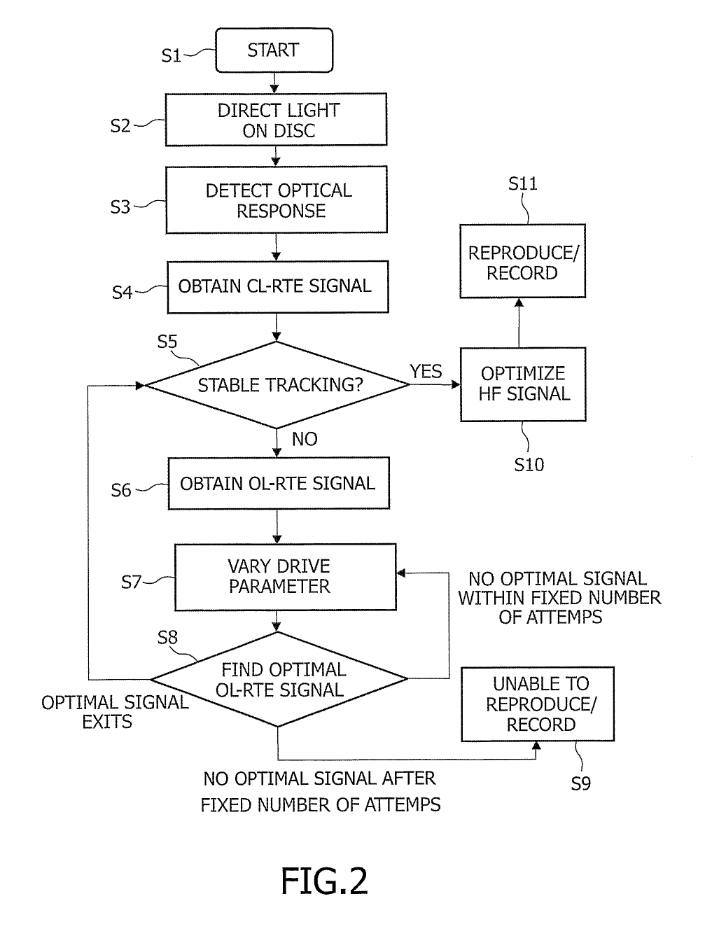

FIG. 2 shows a flow chart illustrating the first aspect of the present invention,

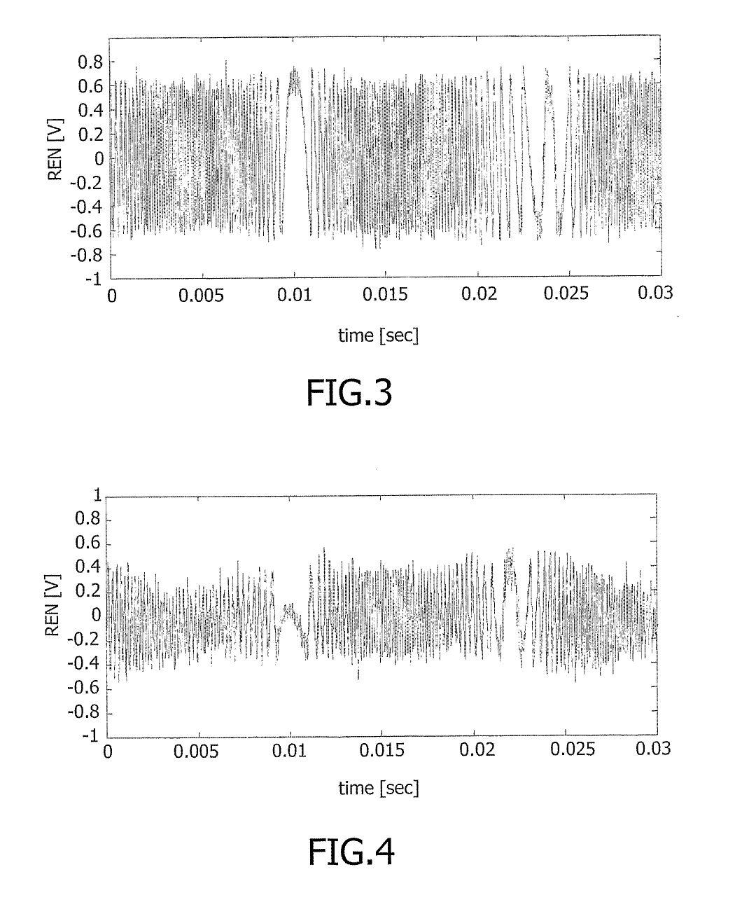

FIG. 3 shows an example of a normalized open loop DTD signal as a function of time for a DVD disk with a thickness within standard thickness.

FIG. 4 shows an example of a normalized open loop DTD signal as a function of time for a DVD disk with thickness above standard thickness.

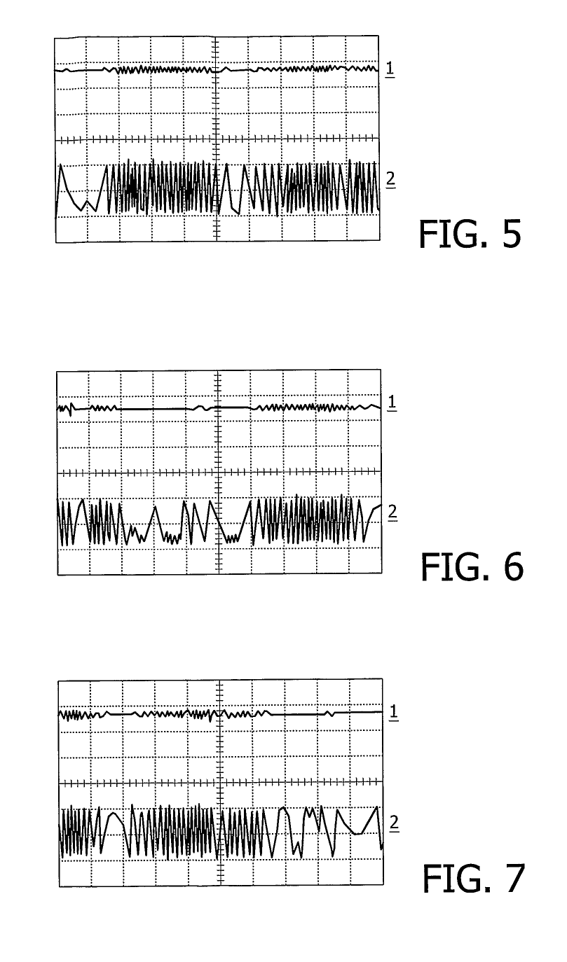

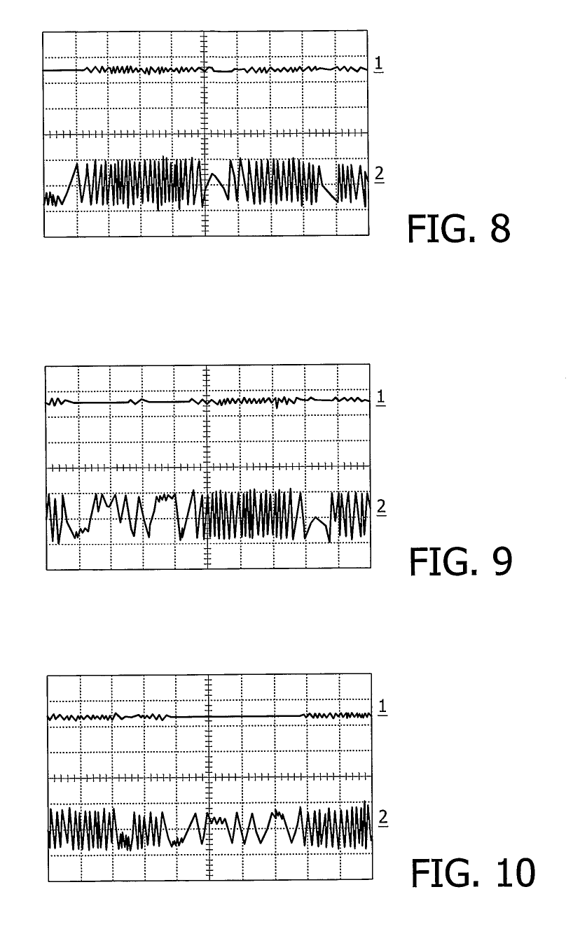

FIGS. 5 to 10 show six plots of normalized open loop DTD signal as a function of time for a DVD disk with thickness below standard thickness, each plot having a different value of the focus offset, and

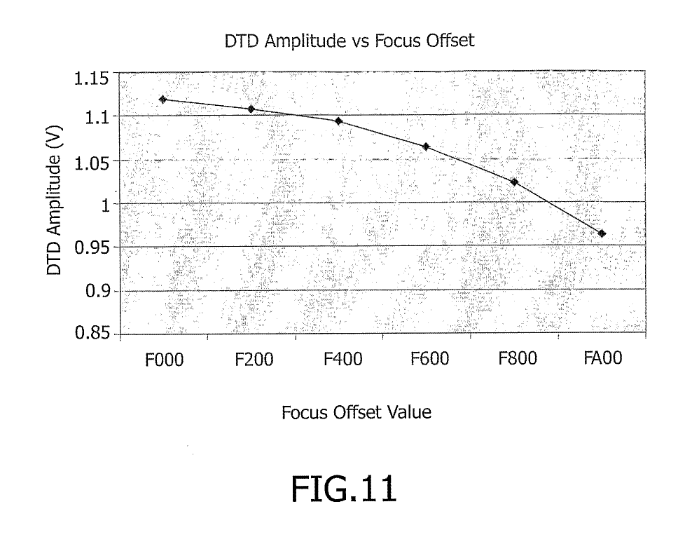

FIG. 11 shows a graph of the six different average amplitudes of the normalized open loop DTD signals of FIGS. 5 to 10 as a function of the focus offset.

FIG. 1 shows a block diagram of a preferred embodiment of the optical disk drive according to the present invention. The optical disk 1 is positioned and fixated on a holder 2 connected to a rotary spindle 3. The optical head 4 of the optical disk drive comprises the optics for reproducing/recording information from/to the optical disk 1. The optical head 1 is positioned on an actuator 5, such as stepping motor or similar, capable of radially displacing the optical head 4 relative to the optical disk 1. The actuator 5 is manipulated by an amplifier 6, which in turn is controlled by the digital signal processor (DSP) 10 of the optical disk drive.

The optical head 4 comprises a light source 20, such as a solid-state laser, which is controlled by control means (not shown) from the DSP 10. The optical head 4 further comprises an objective lens 21, a photodetector 22, and lens actuators 23. The objective lens 21 may be manipulated by the lens actuators 23, the lens actuators 23 being controlled by the DSP 10 through an amplifier 25. The lens actuator 23 enables the objective lens 21 to be focussed in a light spot 30 on the optical disk 1. The optical response of the optical disk 1 is detected by the photodetector 22. In a preferred embodiment the photodetector 22 is divided into four sections, each section functioning as an independent photodetector capable of providing an output 31a-d.

The output 31 from the photodetector 22 is transmitted further and analyzed in three different circuits: the sum signal detection comprehensive circuit 40, the push pull (PP) comprehensive circuit 41, and the differential time detection (DTD) signal detection circuit 42, respectively. Each of the three circuits 40, 41, 42 are further connected to the DSP 10.

In the sum signal detection comprehensive circuit 40, the sum of the four outputs 31a-d is obtained and transmitted to the DSP. The sum of amplitudes of the four outputs 31a-d is known as the radio frequency (RF) signal. The RF signal is transmitted to an analog-to-digital converter (not shown) of the DSP 10 in order to convert the analog information to digital information.

In the push pull (PP) comprehensive circuit 41, a tracking error signal is generated on the basis of the level difference between the outputs 31a-d detected in photodetector 22. From this tracking error signal, radial tracking of the optical disk 1 can be obtained by well-known methods in the art. In short, the DSP 10 will receive the tracking error signal and if necessary send a control signal to the actuator 5 and displace the optical head 4 as needed.

In the DTD signal detection circuit 42, a phase difference between the pairs of the four outputs 31 a-b detected in the photodetector 22 is measured and a radial tracking error signal is generated. From this radial tracking error (RTE) signal, radial tracking can be obtained by a closed loop feedback with the DSP 10 as the controller.

The closed loop schemes exploiting e.g. the DTD signal or the PP signal aims at minimizing the radial tracking error signal as the radial tracking error signal is indicative of the difference between the actual position and the target position in the radial direction. However, various control mechanisms with feedback such as adaptive control, learning control etc. may also be applied for establishing radial tracking. If the control mechanism is successful in correcting the error, i.e. minimizing the radial tracking error signal below a certain preset value, the radial tracking is, in the context of the present application, defined as stable. Preferably, the radial tracking error signal should be below a certain preset value for a given amount of time and/or number of revolutions of the optical disk 1. The preset value of the RTE signal may be a certain average amplitude of the closed loop DTD signal and so forth.

As will be explained below the present invention provides a way of obtaining an optimized radial tracking error signal using an open loop, i.e. with no feedback, in order to improve a subsequent closed loop control mechanism, optionally involving the said radial tracking error signal.

FIG. 2 shows a flow chart illustrating the present invention. The various steps in the flow chart are referenced by capital S followed by consecutive numbers to facilitate clear reference to the various steps of the invention. In the flow chart, the method starts at S1. S1 could for example comprise placing the optical disk 1 in the optical disk drive and spinning up the disk 1 in the drive. At S2, light is directed onto the optical disk 1. Depending on the type of optical disk 1 various kinds of optical response from the disk 1 may result. The next step, S3, is to detect this optical response. First of all, the information stored on the optical disk 1 represented by pits or marks in tracks of the disk 1 is read by detecting the change in the amount of reflected light. Furthermore, as explained above, the optical response may comprise information about the error in the radial position of the optical head 4. At step S4, the optical response is analyzed by obtaining a radial tracking error (RTE) signal, such as a PP signal or a DTD signal. The RTE signal forms part of a closed loop control mechanism where the DSP 10 receives the RTE signal and, depending on the value of the RTE signal and the control mechanism, outputs a control signal to the actuator 5 for displacing the optical head 4 if needed. At step S5, it is determined whether stable radial tracking can be obtained from the closed loop radial tracking error (CL-RTE) signal in step S4. As mentioned above this may be done be comparing for example the amplitude of the DTD signal with a pre-set value. Other alternatives may include the amplitude of the PP signal. Alternatively, the determination of whether stable radial tracking can be obtained is determined by whether phase-lock loop tracking (PLL) of the RF signal may obtained, preferably within 1 millisecond.

If no stable radial tracking can be obtained at S5, the method proceeds to step S6, wherein the RTE signal is obtained but the closed loop control mechanism is temporally disabled, i.e. the RTE signal obtained is an open loop RTE signal, abbreviated an OL-RTE signal. While simultaneously measuring the OL-RTE signal a drive parameter of the optical disk drive is varied at S7. Several variation schemes are possible; a pre-defined interval for variation the drive parameter may be used, the differential variation of e.g. an amplitude of the OL-RTE signal may be used for obtaining a direction of further variation of the drive parameter, a mathematical or statistical model of the behavior of a characteristic associated with the OL-RTE signal, e.g. the amplitude, and so forth. At S8, an optimized value of a characteristic associated with the OL-RTE signal based on the variation performed in step S7 is found. In a preferred embodiment, the average amplitude of an open loop DTD signal is measured, while the focus offset is varied. This embodiment together with experimental data is given in the Examples section below. In the context of the present application, the term “optimized value” does not necessarily refers to a maximum nor does this term necessarily refers to the best value. As used herein, the term “optimized value” refers to a selection of one suitable value over another suitable value. For example, the optimal value of a characteristic associated with the OL-RTE signal may be a local maximum. Furthermore, several drive parameters may be varied in order to obtain an optimal OL-RTE signal, thus a multi-dimensional parameter space may result making it quite demanding to locate an optimal OL-RTE signal corresponding to a portion of the multi-dimensional space.

At step S8, if an optimal value of a characteristic associated with the OL-RTE signal is not obtained, the method may go back to S7 to vary another drive parameter and/or vary the previous drive parameter by another variation scheme. The return step from S8 to S7 is to be performed only a fixed number of times in order to avoid an indefinite number of loops. The step from S8 back to S7 is indicated to the right of S7 and S8 with an arrow. If an optimal value of a characteristic associated with the OL-RTE signal, even after having tried a fixed number of times, is not possible the method may unsuccessful end at S9.

If an optimal OL-RTE signal exits at S8, according to pre-set definition of optimal of the variation scheme in question, the method continues from S8 back to S5 in order to determine whether stable radial tracking can be obtained based on the value of the drive parameter found at S7 and S8. Optionally, more than one value and/or more than one drive parameter can be found at S7 and S8. If affirmative, the method may proceed to S10 where an optimizing step of the RF signal is performed, and finally information can be recorded on the optical disk and/or information can be reproduced from the optical disk at S11. If at S5 no stable radial tracking can be obtained based on the value of the drive parameter found at S7 and S8 even after having found an optimal OL-RTE signal and a corresponding drive parameter setting, the S6-S7-S8 steps can be performed again until stable radial tracking is obtainable at S5. However, an upper limit may advantageously be implemented to avoid an indefinite number of loops.

### EXAMPLES

FIG. 3 shows an example of a normalized open loop DTD signal as a function of time for a DVD disk with a thickness within the standard thickness of a DVD disk which is 570-643 um. For CD disks the standard thickness is 1.2±0.1 mm, while the BD disk standard presently is not well defined. The open loop DTD signal is an example of a OL-RTE signal according to present invention. The normalized open loop DTD signal is labelled “REN[V]” on the vertical axis of the graph shown in FIG. 3. The open loop DTD signal is normalized in this and the following examples with respect to the amplitude of the RF signal. The normalization is performed in the DSP 10. In this and the following examples, the laser spot is tracking in the focus direction but of course not in the radial direction as per definition for an OL-RTE signal.

FIG. 4 shows an example of a normalized open loop DTD signal as a function of time for a DVD disk with a thickness of the disk being in the range 713-725 um, which is well above the standard thickness of DVD disks. Thus, the DVD disk has a parameter with a value outside the standard given for the DVD disk and may be characterized as an out-of-spec DVD disk.

Comparing FIG. 3 with FIG. 4, it is observed that the amplitude of the normalized open loop DTD signal is approximately 0.6 V for the disk of FIG. 3 while the amplitude of the normalized open loop DTD signal for the disk of FIG. 4 is approximately in the range from 0.2-0.4 V. The signal-to-noise ratio (SNR) and the stability of the normalized open loop DTD signal is also observed to be better for the standard disk of FIG. 3 relative to the out-of-spec disk of FIG. 4. With the normalized open loop DTD signal of FIG. 4 it turns out to be very difficult or impossible to achieve stable radial tracking and consequently no information can be obtained from the disk of FIG. 4.

FIGS. 5 to 10 show six plots of normalized open loop DTD signal as a function of time for another DVD disk with a thickness in the range of 507-524 um, which is below standard thickness for DVD disk. The normalized open loop DTD signal is shown in the lower section of the plots, while the focus error signal is displayed in the upper section of the plots. Each of the six plots has a different value of the focus offset. The focus offset is thus an example of a drive parameter of the optical disk drive that is varied while measuring the normalized open loop DTD signal. It is observed that the stability of the normalized open loop DTD signal changed from one focus offset value to another.

FIG. 11 shows a graph of the six different average amplitudes of the normalized open loop DTD signals of FIGS. 5 to 10 as a function of the focus offset. The graph shows a steady decline of the average amplitude of the normalized open loop DTD signal. Thus, if the optimized value is set to be a maximum value of the average amplitude of the normalized open loop DTD signal, the focus offset of the optical disk drive should be chosen to be the focus offset value labeled F00 on the horizontal axis of the graph in FIG. 11.

Although the present invention has been described in connection with the preferred embodiments, it is not intended to be limited to the specific form set forth herein. Rather, the scope of the present invention is limited only by the accompanying claims. In the claims, the term comprising does not exclude the presence of other elements or steps. Additionally, although individual features may be included in different claims, these may possibly be advantageously combined, and the inclusion in different claims does not imply that a combination of features is not feasible and/or advantageous. In addition, singular references do not exclude a plurality. Thus, references to “a”, “an”, “first”, “second” etc. do not preclude a plurality. Furthermore, reference signs in the claims shall not be construed as limiting the scope.

1. A method for improving the optical readout of an optical disk, the method comprising the steps of:
a) directing a light signal onto the optical disk in an optical disk drive,
b) detecting an optical response from the optical disk, and
c) determining whether stable radial tracking can be obtained from the optical response,
if stable radial tracking cannot be provided in step c, the method further comprises the steps of:
d) obtaining an open loop radial tracking error (OL-RTE) signal from the optical response of the optical disk,
e) varying at least one drive parameter of the optical disk drive,
f) determining at least one optimized value of a characteristic associated with the OL-RTE signal based on said variation, said at least one optimized value corresponding to a first drive parameter value of the optical disk drive, and
g) detecting an optical response from the optical disk at substantially the first drive parameter value.

2. The method according to claim 1, wherein the determination of whether stable radial tracking can be obtained in step c comprises a phase-lock loop (PLL) of the optical response.

3. The method according to claim 1, wherein the determination of whether stable radial tracking can be obtained in step c comprises a closed loop radial tracking error (CL-RTE) signal.

4. The method according to claims 3, wherein the CL-RTE signal of step c, and/or the OL-RTE signal of step d, comprises obtaining a differential time detection (DTD) signal from the optical response.

5. The method according to claim 3, wherein the CL-RTE signal of step c, and/or the OL-RTE signal of step d, comprises obtaining a push-pull (PP) signal from the optical response.

6. The method according to claim 1, wherein the optical disk has at least one parameter outside the specifications and/or standards associated with the optical disk.

7. The method according to claim 1, wherein the at least one drive parameter in step e is chosen from the group of: focus offset, collimator position, sledge tilt, lens radial position, lens tilt, and voltage on a compensating liquid crystal.

8. The method according to claim 1, where the method is performed initially before reproducing the information stored on the optical disk and/or recording information on the optical disk.

9. The method according to claim 1, where the method is performed while reproducing the information stored on the optical disk and/or recording information on the optical disk.

10. The method according to claim 1, wherein the at least one drive parameter is varied within an interval between a second drive parameter value and a third drive parameter value, the first drive parameter value, associated with the optimized value of a characteristic of the OL-RTE signal, being at least substantially equal to the second drive parameter value and at the most substantially equal to the third drive parameter value.

11. The method according to claim 1, wherein the at least one drive parameter is varied by increasing from an initial drive parameter value to a fourth drive parameter value, said fourth drive parameter value having a fourth value of a characteristics associated with the OL-RT signal, and decreasing the initial drive parameter value to a fifth drive parameter value, said fifth drive parameter value having a fifth value of a characteristic associated with the OL-RTE signal, and comparing said fourth and said fifth value of a characteristic associated with the OL-RTE signal for determining an optimized value of a characteristic associated with the OL-RTE signal and/or determining a direction for further variation of the drive parameter.

12. The method according to claim 1, wherein the characteristic associated with the OL-RTE signal is chosen from the group consisting of: amplitude, peak-to-peak value, signal-to-noise ratio (SNR), mean value, a summation of a signal, a normalized signal and/or any combination thereof.

13. An apparatus for implementing the method according to claim 1, the apparatus comprising:
holding means adapted to fixate and rotate an optical disk,
an optical head adapted to be displaced by actuation means in a radial direction of the optical disk, the optical head comprising;
a light source providing a light signal,
at least one objective lens adapted to focus the light signal to a light spot onto the optical disk, and
at least one photodetector for detecting an optical response of the optical disk, said at least one photodetector providing a least a first output signal,
at least one analyzing circuit adapted to analyse the at least first output signal and provide a second signal indicative of an error in the radial position of the optical head relative to the optical disk, and
control means adapted to receive the second signal, said control means being capable of providing a control signal, in accordance with a pre-set scheme depending on the second signal, to the actuation means for radially displacing the optical head.

14. A computer program product being adapted to enable a computer system comprising at least one computer having data storage means associated therewith to control the method for improving the optical readout of an optical disk according to claim 1.
